(19) United States
(12) Patent Application Publication
(10) Pub. No.: US 2012/0094209 A1
(43) Pub. Date: Apr. 19, 2012

(54) ION-CONDUCTIVE COMPOSITE, MEMBRANE ELECTRODE ASSEMBLY (MEA), AND ELECTROCHEMICAL DEVICE

(75) Inventors: Kenji Kishimoto, Tokyo (JP); Kazuaki Fukushima, Kanagawa (JP); Takuro Hirakimoto, Kanagawa (JP)

(73) Assignee: SONY CORPORATION, Tokyo (JP)

(21) Appl. No.: 13/380,713

(22) PCT Filed: Jun. 24, 2010
(86) PCT No.: PCT/JP10/61223

§ 371 Date: Dec. 29, 2011

(30) Foreign Application Priority Data
Jul. 1, 2009 (JP) 2009-156559

(51) Int. Cl. H01M 8/10; B82Y 30/00

(52) U.S. Cl. 429/482; 429/494; 429/492; 977/734

(57) ABSTRACT

Provided are an ion-conductive composite containing ion-conductive fine particles and a vinylidene fluoride homopolymer or copolymer and having excellent ion conductivity, a membrane electrode assembly (MEA) including the ion-conductive composite as an electrolyte, and an electrochemical device, such as a fuel cell.

An ion-conductive composite is formed of ion-conductive fine particles having an ion-dissociative group and a vinylidene fluoride homopolymer or copolymer. Here, a vinylidene fluoride homopolymer or copolymer having a β-type crystal structure is used. Since polyvinylidene fluoride having the β-type crystal structure has a large dipole moment in a direction that is orthogonal to the direction of the molecular chain, permittivity in the vicinity of ion-conductive fine particles can be kept high, thus facilitating ionic conduction. As a result, the decrease in ion conductivity can be minimized when the composite is formed.

### TECHNICAL FIELD

The present invention relates to an ion-conductive composite containing ion-conductive fine particles and a vinylidene fluoride homopolymer or copolymer, a membrane electrode assembly (MEA) including the ion-conductive composite as an electrolyte, and an electrochemical device, such as a fuel cell.

### BACKGROUND ART

Fuel cells have high energy conversion efficiency and do not generate pollutants that harm the environment, such as nitrogen oxides, and therefore, research and development has been, actively carried out on fuel cells as power supply devices. Furthermore, in recent years, portable electronic equipment, such as notebook-sized personal computers and cellular phones, has become more sophisticated and multifunctional, and as a result, power consumption has tended to increase. Fuel cells are highly expected as power sources for portable electronic equipment that can respond to this tendency.

In a fuel cell, a fuel is supplied to the negative electrode (anode) side, where the fuel is oxidized. Air or oxygen is supplied to the positive electrode (cathode) side, where oxygen is reduced. In the fuel cell as a whole, the fuel is oxidized by oxygen. In this process, chemical energy possessed by the fuel is efficiently converted to electrical energy, which is taken out. Fuel cells are characterized in that they can be continuously used as a power source by replenishment of fuel, unless they break down.

Various types of fuel cells have already been proposed or made as prototypes, and some of them have been in practical use. Fuel cells are classified into various types depending on the electrolyte they use, such as an alkaline electrolyte-type fuel cell, a phosphoric acid-type fuel cell, a molten carbonate-type fuel cell, a solid oxide-type fuel cell, and a polymer electrolyte-type fuel cell (PEFC). Among these, a PEFC is suitable as a portable power source because the electrolyte of a PEFC is solid and free from the possibility of being scattered, a PEFC can be operated at a low temperature compared with other types of fuel cells, for example, at about 30° C. to 130° C., and the start-up time of a PEFC is short, and for other reasons.

FIG. 4 is a cross-sectional view showing an example of a structure of a fuel cell configured as a PEFC. In a fuel cell 10, an anode (fuel electrode) 12 and a cathode (oxygen electrode) 13 are bonded to both side surfaces of a hydrogen ion (proton)-conductive polymer electrolyte membrane 11 such that the anode 12 and the cathode 13 face each other, thus constituting a membrane electrode assembly (MEA) 14. In the anode 12, a porous anode catalyst layer 12b containing hydrogen ion (proton)-conductive polymer electrolyte particles and electron-conductive catalyst particles is disposed on a surface of a gas-permeable current collector (gas diffusion layer) 12a composed of a porous conductive material, such as a carbon sheet or carbon cloth, thus constituting a gas diffusion electrode. Furthermore, in the cathode 13, in the same manner, a porous cathode catalyst layer 13b containing hydrogen ion (proton)-conductive polymer electrolyte particles and electron-conductive catalyst particles is disposed on a surface of a gas-permeable current collector (gas diffusion layer) 13a composed of a porous support, such as a carbon sheet, thus constituting a gas diffusion electrode. The catalyst particles may be particles composed of a single catalyst material or may be composite particles composed of a catalyst material supported by a carrier.

The membrane electrode assembly (MEA) 14 is sandwiched between a fuel flow channel 21 and an oxygen (air) flow channel 24 and integrated into the fuel cell 10. When electricity is generated, on the anode 12 side, a fuel is supplied from a fuel inlet 22 and discharged from a fuel outlet 23. During this period, part of the fuel passes through the gas-permeable current collector (gas diffusion layer) 12a to reach the anode catalyst layer 12b. As the fuel for the fuel cell, any of various combustible substances, such as hydrogen or methanol, can be used. On the cathode 13 side, oxygen or air is supplied from an oxygen (air) inlet 25 and discharged from an oxygen (air) outlet 26. During this period, part of oxygen (air) passes through the gas-permeable current collector (gas diffusion layer) 13a to reach the cathode catalyst layer 13b.

For example, in the case where the fuel is hydrogen, the hydrogen supplied to the anode catalyst layer 12b is oxidized on the anode catalyst particles in accordance with a reaction expressed by the following reaction formula (1):

2H₂→4H⁺+4e⁻ (1)

to give electrons to the anode 12. The resulting hydrogen ions H⁺ move through the polymer electrolyte membrane 11 to the cathode 13 side. The oxygen supplied to the cathode catalyst layer 13b reacts with the hydrogen ions moved from the anode side on the cathode catalyst particles in accordance with a reaction expressed by the following reaction formula (2):

O₂+4H⁺+4e⁻→2H₂O (2)

to become reduced and take up electrons from the cathode 13. In the fuel cell 10 as a whole, a reaction expressed by the following reaction formula (3), which is a combination of the formulae (1) and (2):

2H₂+O₂→2H₂O (3)

takes place.

A gaseous fuel, such as hydrogen, requires a high-pressure container or the like for storing, and therefore, is not suitable for size reduction. On the other hand, a liquid fuel, such as methanol, is advantageous in that it is easy to store. However, regarding a fuel cell of a type in which hydrogen is extracted from a liquid fuel using a reformer, since the structure becomes complex, this type of fuel cell is not suitable for size reduction. In contrast, a direct methanol-type fuel cell (DMFC), in which methanol is directly supplied to the anode and subjected to reaction instead of first being reformed, is characterized in that the fuel is easy to store, the structure is simple, and the size can be easily reduced. Conventionally, many DMFCs have been combined with PEFCs and researched as a type of PEFC. DMFCs are considered to be most promising as a power source for portable electronic equipment.

Meanwhile, conventionally, as the material for the hydrogen ion-conductive polymer electrolyte membrane 11, perfluorosulfonic acid-based resins, such as Nafion (Registered Trademark of DuPont), have been generally used. Nafion (Registered Trademark) consists of a polymer having a perfluorinated hydrophobic backbone and a perfluorinated side chain having a hydrophilic sulfonic acid group. In Nafion (Registered Trademark), hydrogen ions dissociated from sulfonic acid groups move by diffusion using, as a channel, water incorporated into the polymer matrix, and thus hydrogen ion conductivity is expressed. Accordingly, a Nafion (Registered Trademark) membrane exhibits good proton conductivity in a wet state in which a sufficient amount of water is absorbed.

However, in a state in which the water content is low, the hydrogen ion conductivity of the Nafion (Registered Trademark) membrane decreases sharply. Furthermore, water incorporated into the polymer is retained in a state phase-separated from the hydrophobic polymer backbone, and therefore is unstable. The moisture condition largely changes depending on the temperature, and hydrogen ion conductivity has large temperature dependency. Furthermore, at high temperatures, the moisture is lost by evaporation, and at low temperatures, the moisture is frozen. In order to prevent these phenomena, the fuel cell operating temperature range is limited. Moreover, the Nafion (Registered Trademark) membrane has a low ability of inhibiting methanol permeation, and in a DMFC using the Nafion (Registered Trademark) membrane, methanol crossover significantly decreases the electricity generation performance. Furthermore, in general, perfluorosulfonic acid-based resins have a high material cost, resulting in an increase in the cost of electrochemical devices, such as fuel cells, using them.

Under these circumstances, PTL 1, which will be described below, proposes that a carbonaceous material derivative obtained by introducing proton-dissociative groups into a carbonaceous material having as a main component a carbon cluster, in particular, a carbon cluster having a peculiar molecular structure, such as a fullerene, is used as a material for a hydrogen ion-conductive electrolyte membrane. Note that, in PTL 1, the term “carbon cluster” is defined as an aggregate composed mainly of carbon atoms, in which several to several hundred carbon atoms are bonded together regardless of the type of carbon-carbon bonding, and the term “proton-dissociative group” means a functional group from which a hydrogen atom can be ionized and eliminated as a proton (hydrogen ion H+). In the present application, the terms “carbon cluster” and “proton-dissociative group” are defined as the same as above.

Proton-dissociative molecules obtained by introducing proton-dissociative groups into a carbon cluster, such as a fullerene, in an aggregated state exhibit hydrogen ion conductivity. The reason for this is believed to be that since a large number of proton-dissociative groups are present per molecule of fullerene, the number of proton-dissociative groups contained in a unit volume is very large.

Since then, various fullerene derivatives, such as a fullerene-based polymer in which fullerenes are joined by organic groups, have been synthesized. For example, there have been reports on fullerene derivatives which excel in chemical and thermal stability compared with the fullerene derivative exemplified in PTL 1 and which are suitable as a constituent material of hydrogen ion-conductive electrolyte membranes (e.g., refer to Japanese Unexamined Patent Application Publication Nos. 2003-123793, 2003-187636, 2003-303513, 2004-55562, and 2005-68124).

However, there is a wide variety of performance requirements to be satisfied by the hydrogen ion-conductive electrolyte membrane 11 used in the PEFC 10 or the like. The hydrogen ion-conductive electrolyte membrane 11 is required to have not only high hydrogen ion conductivity but also excellent mechanical strength, moderate flexibility, sufficient capability to prevent permeation (cross leakage) of fuel and oxygen, and excellent water resistance, chemical stability, and heat resistance. There are currently no easily available hydrogen ion-conductive materials that can meet these requirements alone. For example, most fullerene-based hydrogen ion-conductive materials are in the powder form, in which, in some cases, the film formability, mechanical strength and flexibility of the membrane, and the property of preventing permeation of fuel and oxygen may be poor compared to a polymer material having excellent film formability.

Under these circumstances, in each of PTL 1 and PTL 2, which will be described below, a structure is proposed in which by forming a proton-dissociative group-containing carbon cluster derivative and a polymer material having excellent film formability into a composite, the film formability, mechanical strength and flexibility of the membrane, and the property of preventing permeation of fuel and oxygen can be increased.

PTL 1 illustrates, as the polymer material having excellent film formability, polyfluoroethylene such as polytetrafluoroethylene (PTFE), polyvinylidene fluoride (PVDF), and polyvinyl alcohol (PVA).

PTL 2 proposes a proton-conductive composite in which a proton-dissociative group-containing carbon cluster derivative and a polymer material through which liquid molecules, such as water and or alcohol molecules, do not easily pass, are mixed, and the mixing ratio of the polymer material is more than 15% by mass and 95% by mass or less, and more preferably, 20% by mass or more and 90% by mass or less. In this case, the polymer material preferably contains at least a vinylidene fluoride homopolymer or copolymer, and the copolymer is preferably a copolymer with hexafluoropropane.

The following description is included in PTL 2. That is, by employing the structure described above, while maintaining high proton conductivity of the carbon cluster derivative, it is possible to obtain a proton-conductive composite having excellent film formability and mechanical strength and chemical stability of the membrane and excellent capability of blocking permeation of liquid molecules of water, methanol, or the like in the same manner as in the polymer material. In this case, the carbon cluster derivative provides a hydrogen ion transfer pathway having high proton conductivity. On the other hand, the polymer material has functions of blocking movement of liquid molecules of water, methanol, or the like and preventing swelling of the carbon cluster derivative by means of high film formability and mechanical strength.

Furthermore, in PTL 3, which will be described below, amorphous carbon into which a sulfonic acid group is introduced is proposed as a hydrogen ion-conductive material having high proton conductivity and excellent heat resistance and capable of being produced at low cost. This material can be produced by subjecting an organic compound to heat treatment in concentrated sulfuric acid or fuming sulfuric acid. In this process, carbonization, sulfonation, and ring fusion occur, thereby producing sulfonic acid group-introduced amorphous carbon. As the organic compound which is a raw material, an aromatic hydrocarbon can be used. Alternatively, a natural product such as sugar or a synthetic polymer compound may be used, or a raw material other than a refined organic compound, for example, heavy oil, pitch, tar, or asphalt containing aromatic hydrocarbons, may be used.

Since the solid acid described above is in the powder form, the solid acid and a polymer material having excellent formability must be formed into a composite to enable film formation. PTL 3 describes that, by using, as a binder polymer, a homopolymer or copolymer of a fluorine-containing monomer, such as tetrafluoroethylene, chlorotrifluoroethylene, vinyl fluoride, vinylidene fluoride, hexafluoropropane, or perfluoroalkyl vinyl ether, stability of the electrolyte membrane improves dramatically.

### CITATION LIST

### Patent Literature

PTL 1: WO01/06519 (claims 1, 4, 5, 16, and 18, pages 3, 6 to 11, 13, and 14, FIGS. 1 to 5 and 7)
PTL 2: Japanese Unexamined Patent Application Publication No. 2005-93417 (pages 8 and 12 to 14, FIGS. 1 to 4, 6, and 7)
PTL 3: Japanese Unexamined Patent Application Publication No. 2006-257234 (pages 3 and 5 to 8, FIG. 1)

### SUMMARY OF INVENTION

### Technical Problem

As described above, by forming a composite using ion-conductive fine particles having an ion-dissociative group, such as a carbon cluster derivative or sulfonic acid group-introduced amorphous carbon, and a fluorine-containing resin, such as a vinylidene fluoride homopolymer or copolymer, it is possible to obtain a composite which has ion conductivity and which excels in film formability, and mechanical strength and chemical stability of the membrane. In particular, since the fluorine-containing resin has excellent capability of blocking permeation of water, methanol, or the like, by producing a hydrogen ion-conductive electrolyte membrane using the composite, it is possible to construct a fuel cell suitable as a direct methanol-type fuel cell (DMFC).

Here, in the case where an additive that does not have an ion-dissociative group and does not contribute to ionic conduction, such as the fluorine-containing resin, is used, the ion conductivity of the composite generally tends to decrease. Consequently, in order to maintain the ion conductivity of the composite as high as possible, it is necessary to select a material by which electrochemical characteristics of ion-conductive fine particles are degraded as little as possible as the polymer material used for film formation together with the ion-conductive fine particles.

The present invention has been achieved in order to solve the problems described above. It is an object of the present invention to provide an ion-conductive composite containing ion-conductive fine particles and a vinylidene fluoride homopolymer or copolymer and having excellent ion conductivity, a membrane electrode assembly (MEA) including the ion-conductive composite as an electrolyte, and an electrochemical device, such as a fuel cell.

### Solution to Problem

That is, the present invention relates to an ion-conductive composite containing ion-conductive fine particles having an ion-dissociative group and a vinylidene fluoride homopolymer or copolymer including a portion having a β-type crystal structure.

The present invention also relates to a membrane electrode assembly in which the ion-conductive composite serving as an electrolyte is sandwiched between opposing electrodes, and an electrochemical device in which the ion-conductive composite serving as an electrolyte is sandwiched between opposing electrodes, thus constituting an electrochemical reaction section.

### Advantageous Effects of Invention

An ion-conductive composite according to the present invention is an ion-conductive composite containing ion-conductive fine particles having an ion-dissociative group and a vinylidene fluoride homopolymer or copolymer and characterized in that the vinylidene fluoride homopolymer or copolymer includes a portion having a β-type crystal structure. The present inventors have conducted diligent studies and thus have found that, by employing the constitution described above, the decrease in ion conductivity can be minimized when the composite is formed. As a result, it has been possible to obtain an ion-conductive composite which has excellent ion conductivity, excellent film formability and mechanical strength and chemical stability of the membrane, and excellent capability of blocking permeation of water, methanol, or the like.

A membrane electrode assembly (MEA) and an electrochemical device according to the present invention each include the ion-conductive composite of the present invention. Therefore, without substantially impairing electrochemical characteristics, it is possible to improve mechanical strength and chemical stability of the electrolyte membrane, thus improving production yield and durability. Furthermore, since the capability of blocking permeation of water, methanol, or the like is excellent, it is possible to constitute a fuel cell which is suitable as a direct methanol-type fuel cell (DMFC).

### BRIEF DESCRIPTION OF DRAWINGS

FIG. 1 includes perspective views showing a β-type crystal structure and an α-type crystal structure of PVDF according to a first embodiment of the present invention.

FIG. 2 shows Raman spectra of P(VDF-HFP) copolymer samples according to the same.

FIG. 3 is a graph showing hydrogen ion conductivity of hydrogen ion-conductive composite films obtained in Example 1 and Comparative Example 1 at varied relative humidity according to the same.

FIG. 4 is a cross-sectional view showing an example of a structure of a fuel cell configured as a PEFC.

### DESCRIPTION OF EMBODIMENTS

In the ion-conductive composite of the present invention, preferably, the ratio r of the portion having the β-type crystal structure defined by the formula:

r=(β-type crystal structure portion)/((β-type crystal structure portion)+(α-type crystal structure portion))

is 0.1 or more. Desirably, the ratio r is 0.5 or more, and more desirably, the ratio r is 0.9 or more.

Furthermore, preferably, the vinylidene fluoride copolymer is a copolymer with hexafluoropropane (HFP) or tetrafluoroethylene (TFE).

Furthermore, preferably, the ion-conductive fine particles are composed of a carbon cluster or amorphous carbon having the ion-dissociative group. In this case, preferably, the carbon cluster is at least one selected from the group consisting of spherical carbon cluster molecules Cₙ (n is equal to 36, 60, 70, 76, 78, 80, 82, 84, and the like; commonly known as a fullerene).

Furthermore, preferably, the ion-dissociative group includes any one of a proton H⁺, a lithium ion Li⁺, a sodium ion Na⁺, a potassium ion K⁺, a magnesium ion Mg²⁺, a calcium ion Ca²⁺, a strontium ion Sr²⁺, and a barium ion Ba²⁺.

Preferably, the ion-dissociative group is a hydrogen ion-dissociative group, and the ion-conductive composite has hydrogen ion conductivity. In this case, the hydrogen ion-dissociative group is preferably at least one group selected from the group consisting of a hydroxyl group —OH, a sulfonic acid group —SO₃H, a carboxyl group —COOH, a phosphono group —PO(OH)₂, a dihydrogenphosphate ester group —O—PO(OH)₂, a phosphonomethano group >CH(PO(OH)₂), a diphosphonomethano group >C(PO(OH)₂)₂, a phosphonomethyl group —CH₂(PO(OH)₂), a diphosphonomethyl group —CH(PO(OH)₂)₂, a phosphine group —PHO(OH), —PO(OH)—, and —O—PO(OH)—. The term “methano group >CH₂” herein refers to an atomic group in which two linking bonds of a carbon atom of the methano group form single bonds with two carbon atoms of the carbon cluster, thereby forming a cross-link.

The electrochemical device according to the present invention is preferably configured as a fuel cell.

Preferred embodiments of the present invention will now be described specifically and in detail with reference to the drawings.

### First Embodiment

In a first embodiment, examples of ion-conductive composites according to Claims 1 to 10 will be mainly described.

In order to produce an ion-conductive composite according to the first embodiment of the present invention, first, a carbon cluster derivative having an ion-dissociative group is added to an appropriate organic solvent and uniformly dispersed by stirring. Then, powder of a vinylidene fluoride homopolymer or copolymer is added to the resulting dispersion liquid, followed by stirring to prepare a coating liquid. Next, the coating liquid thus prepared is uniformly spread over a substrate to form a coating film. The solvent is gradually evaporated from the coating film, thereby to produce a film-like, ion-conductive composite.

The thickness of the ion-conductive composite film can be controlled by changing the concentration of the coating liquid to be applied and the coating amount per unit area, or the like.

Furthermore, as the organic solvent, cyclopentanone, acetone, propylene carbonate, γ-butyrolactone, or the like can be used. Furthermore, as the substrate, a glass plate, or a film or sheet composed of an organic polymer resin, such as polyimide, polyethylene terephthalate (PET), or polypropylene (PP), can be used.

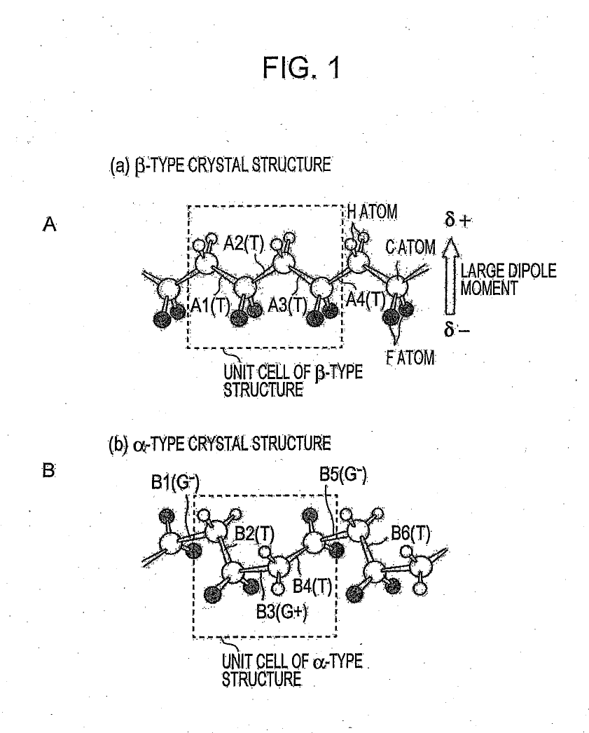

The present invention is characterized in that the vinylidene fluoride homopolymer or copolymer includes a portion having a β-type crystal structure. Regarding polyvinylidene fluoride (PVDF), there are three types of conformation with a stable main chain, and in combination with two types of molecular packing, there are six types of crystal form. FIG. 1 includes perspective views showing a β-type crystal structure and an α-type crystal structure, which are related to the present invention, among them.

As shown in FIG. 1(a), in the β-type crystal structure, the unit cell consists of two monomer molecules, and all of the C—C bonds (A1 to A4) constituting the main chain have a trans (T) conformation, resulting in formation of a TTTT conformation. That is, the bond A1 and the bond A3 are in a trans (T) conformation with respect to the bond A2, and the bond A2 and the bond A4 are in a trans (T) conformation with respect to the bond A3. The same applies to other C—C bonds.

In the β-type crystal structure, structural units originating from two monomer molecules are oriented in the same direction. Consequently, hydrogen atoms having a low electronegativity are always located on one side (upper side in the drawing) of the main chain, and fluorine atoms having a high electronegativity are always located on the opposite side (lower side in the drawing). Therefore, PVDF having the β-type crystal structure has a large dipole moment in a direction that is orthogonal to the direction of the molecular chain. The dipole moment exhibited by PVDF becomes maximum when PVDF has the β-type crystal structure, and PFDF having the β-type crystal structure is used as a ferroelectric polymer in piezoelectric devices and the like.

On the other hand, as shown in FIG. 1(b), in the α-type crystal structure, the unit cell consists of two monomer molecules, but C—C bonds (B2 to B5) constituting the main chain form a TG⁺TG⁻ conformation. That is, the bond B1 and the bond B3, which are located on both sides of the bond B2, are in a trans (T) conformation with respect to the bond B2, and the bond B3 and the bond B5, which are located on both sides of the band B4, are in a trans (T) conformation with respect to the bond B4. However, with respect to the bond B3, a C—F bond is located at a trans position to the bond B4, and the bond B2 is located at a position rotated clockwise by 120° from the C—F bond around the bond B3 being an axis. The bond B4 and the bond B2 are in a gauche (G⁺) conformation. Furthermore, with respect to the bond B5, a C—H bond is located at a trans position to the bond B4, and the bond B6 is located at a position rotated counterclockwise by 120° from the C—H bond around the bond B5 being an axis. The bond B4 and the bond B6 are in a gauche (G⁻) conformation.

In the α-type crystal structure, among the polarities generated by the structural units originating from two monomer molecules, components oriented in a direction that is orthogonal to the direction of the molecular chain (the direction of the bonds B1, B3, and B5) are antiparallel to each other, cancel each other out, and disappear. Therefore, the dipole moment exhibited by PVDF having the α-type crystal structure is small.

When PVDF in a molten state is cooled and crystallized, PVDF having the α-type crystal structure is produced, and thus the α-type structure is considered to be the stablest structure. Furthermore, PVDF produced by a radical polymerization method usually forms the α-type structure. In order to transform PVDF having the α-type crystal structure into PVDF having the β-type crystal structure, a complex post process, such as stretching treatment, heat treatment under high pressure, or rapid cooling under high pressure during casting, is required. Furthermore, PVDF having the γ-type crystal structure, which is another conformation, is obtained by subjecting PVDF having the α-type crystal structure to heat treatment at a temperature of 170° C. or higher (for example, refer to Netsu Sokutei, 29, 192-198 (2002)).

The present inventors have conducted diligent studies and, as a result, have found that in the case where PVDF for forming a composite with ion-conductive fine particles has the β-type crystal structure, when the composite is formed, the decrease in ion conductivity can be minimized. The reason for this is not fully clear, but it is believed that the difference in polarization described above is related to this. That is, since the β-type crystal structure has a large dipole moment, permittivity in the vicinity of ion-conductive fine particles can be kept high, thus facilitating ionic conduction. In contrast, since the dipole moment of the α-type crystal structure is small, permittivity in the vicinity of ion-conductive fine particles cannot be kept high, resulting in difficulty in ionic conduction.

Regarding the case where ion conductivity is changed by a change in permittivity of a polymer electrolyte, an example has been reported in which, in a composite electrolyte including polyvinyl acetate and polyvinylidene fluoride, by changing the mixing ratio of the two components, permittivity of the composite electrolyte is changed, and as a result, ion conductivity of lithium perchlorate changes by slightly more than 10 times to slightly less than 100 times (Mater. Chem. Phys., (2006), 98, 55-61).

The ratio of the β-type crystal structure and the α-type crystal structure (and γ-type crystal structure) contained in the vinylidene fluoride homopolymer or copolymer can be determined by measuring Raman spectra or infrared absorption spectra (for example, refer to Japanese Unexamined Patent Application Publication No. 2005-200623).

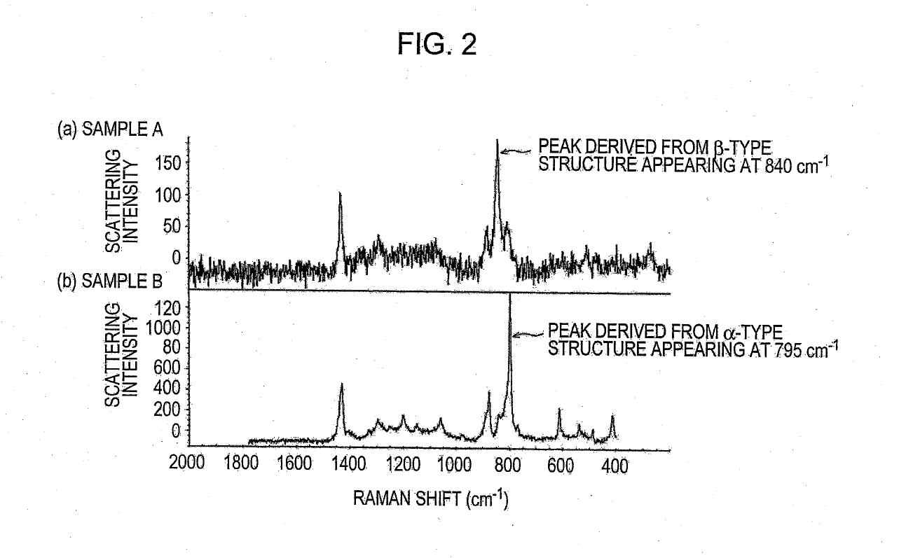

FIG. 2 shows Raman spectra of Sample A and Sample B of the copolymers P(VDF-HFP) of vinylidene fluoride and hexafluoropropane used in Example 1 and Comparative Example 1, respectively, which will be described later. As shown in FIG. 2(a), in Sample A, while a peak is observed at 840 cm⁻¹ attributed to the β-type crystal structure, almost no peak is observed at 795 cm⁻¹ attributed to the α-type crystal structure. Therefore, it is evident that in Sample A, PVDF predominantly has the β-type crystal structure. On the other hand, in Sample B, while a peak is observed at 795 cm⁻¹, almost no peak is observed at 840 cm⁻¹. Therefore, it is evident that in Sample B, PVDF predominantly has the α-type crystal structure (for example, refer to A. Martinelli et al., Solid State Ionics, (2007), 178, 527-531).

In the ion-conductive composite, the ratio r of the portion having the β-type crystal structure is defined by the formula: r=(β-type crystal structure portion)/((β-type crystal structure portion)+(α-type crystal structure portion)). The ratio r is not particularly limited. However, since a sufficient effect cannot be obtained at less than 0.1, the ratio r is preferably 0.1 or more. Desirably, the ratio r is 0.5 or more, and the portion having the β-type crystal structure is mainly present. More desirably, the ratio r is 0.9 or more, and the portion having the β-type crystal structure is mostly present. When the ratio r exceeds 0.9, even if the ratio is brought closer to 1, the effect thereof is small, and the difficulty in achieving this increases. Therefore, preferably, the ratio r exceeds 0.9 without large difficulty.

Preferably, the vinylidene fluoride copolymer is a copolymer with hexafluoropropane (HFP) or tetrafluoroethylene (TFE). In the vinylidene fluoride copolymer, in particular, the copolymer with HFP or TFE, the crystallinity of PVDF is suppressed, film formability is excellent, and the capability of blocking permeation of methanol is high.

Furthermore, base fine particles of the ion-conductive fine particles are not particularly limited. For example, the base fine particles may be composed of a carbon cluster or amorphous carbon on which many research and development has been conventionally performed. A carbon cluster derivative having an ion-dissociative group may be appropriately selected from fullerene derivatives, for example, exemplified in PTLs 1 and 2 and Japanese Unexamined Patent Application Publication Nos. 2003-123793, 2003-187636, 2003-303513, 2004-55562, and 2005-68124, in view of ion conductivity, and chemical and thermal stability, and depending on the operating conditions and the like. Fullerenes are composed of spherical carbon cluster molecules Cₙ (n is equal to 36, 60, 70, 76, 78, 80, 82, 84, or the like), and in particular, C₆₀ and/or C₇₀ is preferable. In the fullerene production methods currently employed, the production rate of C₆₀ and C₇₀ is overwhelmingly high, and use of C₆₀ and/or C₇₀ has a high merit in terms of production cost. Note that the carbon cluster derivative is not limited to fullerene derivatives, and derivatives of other carbon nanoparticles, such as carbon nanohorns, may be used. Furthermore, it may be possible to use an inexpensive carbon material, such as petroleum pitch, into which an acidic group, such as a sulfonic acid group, is introduced.

The ion-dissociative group contained in the carbon cluster derivative is not particularly limited, but preferably, any one of a proton H⁺, a lithium ion Li⁺, a sodium ion Na⁺, a potassium ion K⁺, a magnesium ion Mg⁺, a calcium ion Ca²⁺, a strontium ion Sr²⁺, and a barium ion Ba²⁺ is contained.

In particular, preferably, the ion-dissociative group is a hydrogen ion-dissociative group, and the carbon cluster derivative has hydrogen ion conductivity. In this case, the hydrogen ion-dissociative group is at least one group selected from the group consisting of a hydroxyl group —OH, a sulfonic acid group —SO₃H, a carboxyl group —COOH, a phosphono group —PO(OH)₂, a dihydrogenphosphate ester group —O—PO(OH)₂, a phosphonomethano group >CH(PO(OH)₂), a diphosphonomethano group >C(PO(OH)₂)₂, a phosphonomethyl group —CH₂(PO(OH)₂), a diphosphonomethyl group —CH(PO(OH)₂)₂, a phosphine group —PHO(OH), —PO(OH)—, and —O—PO(OH)—.

### Second Embodiment

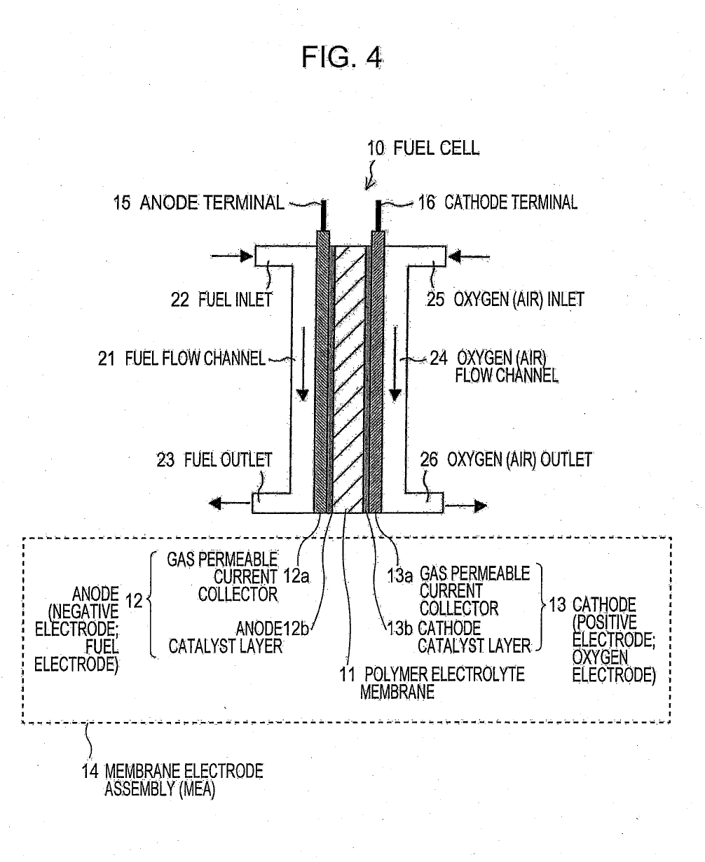

In a second embodiment, there will be mainly described membrane electrode assemblies (MEAS) according to Claims 11 to 13 and an example in which an ion-conductive composite produced in the first embodiment is applied to the fuel cell 10 described with reference to FIG. 4, as an example of an electrochemical device.

### <Production of Membrane Electrode Assembly (MEA)>

A hydrogen ion-conductive composite film produced in the first embodiment is cut into an appropriate planar shape. The resulting film is interposed between an anode 22 and a cathode 23, and press-bonding under heating is performed, for example, at a temperature of 130° C. under a pressure of 0.5 kN/cm² for 15 minutes, to produce a membrane electrode assembly 14.

The membrane electrode assembly (MEA) 14 is sandwiched between a fuel flow channel 21 and an oxygen (air) flow channel 24 and integrated into a fuel cell 10, as described with reference to FIG. 4. When electricity is generated, on the anode 12 side, a fuel, such as hydrogen, is supplied from a fuel inlet 22 and discharged from a fuel outlet 23. During this period, part of the fuel passes through a gas-permeable current collector (gas diffusion layer) 12a to reach an anode catalyst layer 12b. As the fuel for the fuel cell, any of various combustible substances, such as hydrogen or methanol, can be used. On the cathode 13 side, oxygen or air is supplied from an oxygen (air) inlet 25 and discharged from an oxygen (air) outlet 26. During this period, part of oxygen (air) passes through a gas-permeable current collector (gas diffusion layer) 13a to reach a cathode catalyst layer 13b.

In the case where the fuel cell is a direct methanol-type fuel cell (DMFC), methanol serving as the fuel is supplied as an aqueous solution of methanol or pure methanol, and vaporized methanol molecules reach the anode catalyst layer 12b. The methanol molecules are oxidized on the anode catalyst particles in accordance with a reaction expressed by the following reaction formula (4):

CH₃OH+H₂O→CO₂+6H⁺+6e⁻ (4)

to give electrons to the anode 12. The resulting hydrogen ions H⁺ move through the polymer electrolyte membrane 11 to the cathode 13 side. The oxygen supplied to the cathode catalyst layer 13b reacts with the hydrogen ions moved from the anode side on the cathode catalyst particles in accordance with a reaction expressed by the following reaction formula (5):

(3/2)O₂+6H⁺+6e⁻→3H₂O (5)

to become reduced and take up electrons from the cathode 13. In the fuel cell as a whole, a reaction expressed by the following reaction formula (6), which is a combination of the formulae (4) and (5):

CH₃OH+(3/2)O₂→CO₂+2H₂O (6)

takes place.

### EXAMPLES

In Example and Comparative Example, first, using a fullerene-based proton-conductive polymer as a carbon cluster derivative and Sample A and Sample B as samples of P(VDF-HFP) copolymer, hydrogen ion-conductive composite films were produced as described in the first embodiment. The hydrogen ion conductivity of each hydrogen ion-conductive composite film was measured. Next, using the hydrogen ion-conductive composite film as an electrolyte, the membrane electrode assembly 14 and the fuel cell 10, which are described in the second embodiment, were produced, and the electricity generation performance was examined. It is to be noted that the present invention is of course not limited to the example described below.

### Example 1

### Production of Hydrogen Ion-Conductive Composite Film

As a carbon cluster derivative, an appropriate amount of a fullerene-based proton-conductive polymer represented by the structural formula (1) below was added to γ-butyrolactone (manufactured by Wako Pure Chemical Industries, Ltd., special grade) and uniformly dispersed by stirring for 2 hours. Powder of a copolymer P(VDF-HFP) of vinylidene fluoride and hexafluoropropane was added to the resulting dispersion liquid, and as necessary, an appropriate amount of solvent was further added, followed by stirring for 3 hours or more with the temperature being kept at 80° C. to achieve uniform dispersion. In this process, Sample A of P(VDF-HFP) including PVDF predominantly having the β-type crystal structure, which has been described as the characteristic of the present invention with reference to FIGS. 1 and 2, was used.

Structural formula (1) of fullerene-based proton-conductive polymer:

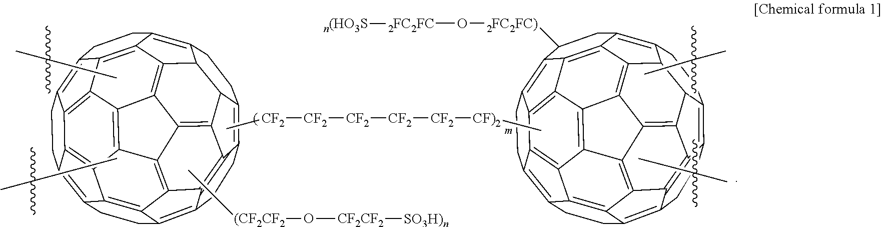

Next, the coating liquid thus prepared was uniformly spread over a polypropylene sheet to form a coating film. The solvent was gradually evaporated from the coating film in a clean bench, thereby to produce a film-like, ion-conductive composite. Furthermore, the resulting thin film was placed in a dryer kept at 60° C. for 3 hours to evaporate the solvent, and thus drying was performed. The thickness of the thin film after drying was 12 μm.

The thickness of the ion-conductive composite film can be controlled by changing the concentration of the coating liquid to be applied and the coating amount per unit area, or the like. For example, by setting the concentration of the coating liquid at 0.01 to 0.030 by mass ratio relative to the solvent and by changing the thickness of the coating film to 30 to 2,000 μm depending on the concentration, the thickness of the ion-conductive composite film can be controlled to about 3 to 50 μl.

### Comparative Example 1

In Comparative Example 1, instead of Sample A, Sample B of P(VDF-HFP) including PVDF predominantly having the α-type crystal structure, which has been described with reference to FIGS. 1 and 2, was used. Other than this, in the same manner as in Example 1, a hydrogen ion-conductive composite film was produced.

Table 1 shows the crystal structure of P(VDF-HFP), film thickness, and mass percentage of the fullerene-based proton-conductive polymer and P(VDF-HFP) sample of the hydrogen ion-conductive composite films produced in Example 1 and Comparative Example 1.

TABLE 1

| | | Film thickness (at the | mass % | |
|---|---|---|---|---|
| | P(VDP-HFP) | time of production) | Fullerene | P(VDP- |
| | Structure | (μm) | derivative | HFP) |
| Example 1 | β type | 12 | 63 | 37 |
| Comparative | α type | 12 | 63 | 37 |
| Example 1 | | | | |

### <Measurement of Hydrogen Ion Conductivity of Hydrogen Ion-Conductive Composite Film>

A cell was fabricated in which the resulting electrolyte membrane was sandwiched between a pair of gold electrodes and fastened at three points with a constant torque, and the cell was placed in a thermo-hygrostat oven set at a temperature of 50° C. The hydrogen ion conductivity of the hydrogen ion-conductive composite film was measured by a complex impedance method. At each humidity, the sample was left to stand in the thermo-hygrostat oven for at least 3 hours until the impedance data did not change with time, and then the value was obtained and used as the measurement result. The relative humidity was varied in the range of 50% to 90%.

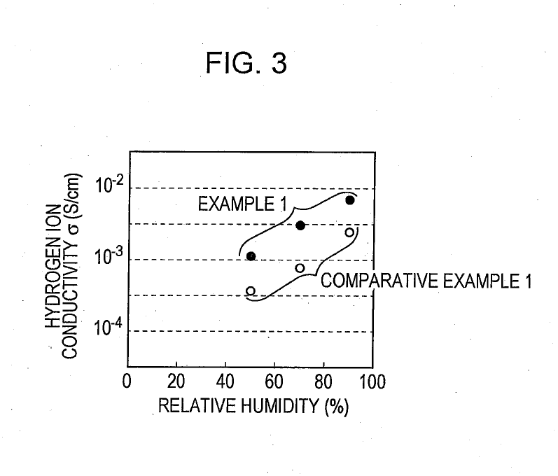

FIG. 3 is a graph showing the measurement results of hydrogen ion conductivity of the hydrogen ion-conductive composite films obtained in Example and Comparative Example. As shown in FIG. 3, in each of the humidity regions measured, the ion conductivity of the hydrogen ion-conductive composite film obtained in Example 1 was about 2.8 to 3.1 times the ion conductivity of the hydrogen ion-conductive composite film obtained in Comparative Example 1. Given the same film thickness of the hydrogen ion-conductive composite film and the same mixing ratio by mass between fullerene-based proton-conductive polymer and P(VDF-HFP) sample, it is obvious that the difference was caused by the difference in the crystal structure of P(VDF-HFP). That is, by constituting the hydrogen ion-conductive composite film using P(VDF-HFP) in which PVDF had the β-type crystal structure, it was possible to minimize the decrease in ion conductivity when the composite was formed.

### <Production of Membrane Electrode Assembly (MEA) and Fuel Cell Assembly>

The hydrogen ion-conductive composite film was cut into a square of 25 mm×25 mm and used as an electrolyte membrane 11. The electrolyte membrane 11 was interposed between an anode 12 and a cathode 13, each having a square planar shape of 13 mm×13 mm, and press-bonding under heating was performed at a temperature of 130° C. under a pressure of 0.5 kN/cm² for 15 minutes, to produce a membrane electrode assembly 14. As each of the anode 12 and the cathode 13, a gas diffusion electrode was used in which a coating liquid obtained by mixing catalyst particles and a Nafion (Registered Trademark) dispersion liquid (trade name: DE-1021; manufactured by DuPont) was applied onto carbon paper (trade name: TPG-H-090; manufactured by Toray Industries, Inc.), the solvent was evaporated, and a catalyst layer was formed. As catalyst particles used in the electrodes, a supported catalyst in which a platinum catalyst Pt was supported by carbon black (manufactured by Tanaka Kikinzoku Kogyo K.K., amount of platinum supported: 70%) and a supported catalyst in which a platinum ruthenium alloy catalyst PtRu was supported by carbon black (manufactured by E-TEK Corp., Pt:Ru=2:1) were used.

### <Electricity Generation Performance of Fuel Cell Assembly>

The membrane electrode assembly (MEA) 14 was incorporated into a fuel cell 10. An electricity generation test was performed, in which pure methanol as a fuel was supplied to the anode 12, and air was supplied by natural air intake to the cathode 13. In this case, two fuel cells 10 were used for each example, and the cell temperature during the electricity generation test was set at 45° C. and 50° C. using a temperature controller, and the electricity generation test was carried out. The results are shown in Table 2.

TABLE 2

| | | Output density (mW/cm²) | |
|---|---|---|---|
| | | 45° C. | 50° C. |
| Example 1 | Cell 1 | 59.4 | 64.0 |
| | Cell 2 | 60.4 | 63.7 |
| Comparative Example 1 | Cell 1 | 52.8 | 59.9 |
| | Cell 2 | 56.8 | 63.5 |

It is evident that, at either temperature, the output density is larger in Example 1 in which the hydrogen ion-conductive composite film was formed using Sample A of P(VDF-HFP) including PVDF predominantly having the β-type crystal structure than Comparative Example 1 in which the hydrogen ion-conductive composite film was formed using Sample A of P(VDF-HFP) including PVDF predominantly having the α-type crystal structure. The reason for this is believed to be that the difference in hydrogen ion conductivity between the hydrogen ion-conductive composite films appears as the difference in the output density of the fuel cell.

The present invention has been described on the basis of the embodiment and examples. However, it is to be understood that the examples can be appropriately modified, on the basis of the technical spirit of the present invention, within a range not deviating from the gist of the present invention.

### INDUSTRIAL APPLICABILITY

The ion-conductive composite of the present invention and the production method therefor can improve the production yield of ion conductive electrolyte membranes and contribute to widespread use of electrochemical devices, such as fuel cells.

### REFERENCE SIGNS LIST

10 fuel cell
11 hydrogen ion (proton)-conductive polymer electrolyte membrane
12 anode (negative electrode; fuel electrode)
12a gas-permeable current collector (gas diffusion layer)
12b anode catalyst layer
13 cathode (positive electrode; oxygen electrode)
13a gas-permeable current collector (gas diffusion layer)
13b cathode catalyst layer
14 membrane electrode assembly (MEA)
15 anode terminal
16 cathode terminal
21 fuel flow channel
22 fuel inlet
23 fuel outlet
24 oxygen (air) flow channel
25 oxygen (air) inlet
26 oxygen (air) outlet)

1-13. (canceled)

14. An ion-conductive composite comprising:
ion-conductive fine particles having an ion-dissociative group, and
a vinylidene fluoride homopolymer or copolymer including a portion having a β-type crystal structure.

15. The ion-conductive composite of claim 14, wherein a ratio r of the portion having the β-type crystal structure is defined by the formula:
r=(β-type crystal structure portion)/((β-type crystal structure portion)+(α-type crystal structure portion))
wherein the ratio r is 0.1 or more.

16. The ion-conductive composite of claim 16, wherein the ratio r of the portion having the β-type crystal structure is 0.5 or more.

17. The ion-conductive composite of claim 16, wherein the ratio r of the portion having the β-type crystal structure is 0.9 or more.

18. The ion-conductive composite of claim 14, wherein the vinylidene fluoride copolymer is a copolymer with at least one of hexafluoropropane and tetrafluoroethylene.

19. The ion-conductive composite of claim 14, wherein the ion-conductive fine particles are composed of at least one of a carbon cluster and a amorphous carbon having the ion-dissociative group.

20. The ion-conductive composite of claim 19, wherein the carbon cluster is a spherical carbon cluster molecule Cₙ, wherein n is equal to one of 36, 60, 70, 76, 78, 80, and 82.

21. The ion-conductive composite of claim 19, wherein the carbon cluster is a fullerene.

22. The ion-conductive composite of claim 14, wherein the ion-dissociative group includes any one of a proton H⁺, a lithium ion Li⁺, a sodium ion NA⁺, a potassium ion K⁺, a magnesium ion Mg²⁺, a calcium ion Ca²⁺, s strontium ion Sr²⁺, and a barium ion Ba²⁺.

23. The ion-conductive composite of claim 22, wherein the ion-dissociative group is a hydrogen ion-dissociative group, and the ion-conductive composite has hydrogen ion conductivity.

24. The ion-conductive composite of claim 23, wherein the hydrogen ion-dissociative group is at least one group selected from the group consisting of a hydroxyl group —OH, a sulfonic acid group —SO₃H, a carboxyl group, —COOH, a phosphono group —PO(OH)₂), a diphosphonomethano group —C(PO(OH)₂)₂, a phosphonomethyl group —CH₂(PO(OH)₂), a diphosphonomethyl group —CH(PO(OH))₂)₂, a phosphine group —PHO(OH), —PO(OH)—, and —O—PO(OH)—.

25. A membrane electrode assembly (MEA) comprising the ion-conductive composite of claim 14, the ion-conductive composite serving as an electrolyte and being sandwiched between opposing electrodes.

26. An electrochemical device comprising the ion-conductive composite of claim 14, the ion-conductive composite serving as an electrolyte and being sandwiched between opposing electrodes to constitute an electrochemical reaction section.

27. The electrochemical device of claim 26, wherein the electrochemical device is configured as a fuel cell.
